(19) United States
(12) Patent Application Publication
(10) Pub. No.: US 2021/0286715 A1
(43) Pub. Date: Sep. 16, 2021

(54) TEST DEVICE, TEST METHOD, AND COMPUTER READABLE MEDIUM

(71) Applicant: Mitsubishi Electric Corporation, Tokyo (JP)

(72) Inventors: Yuya ONO, Tokyo (JP); Hirotaka MOTAI, Tokyo (JP); Takehisa MIZUGUCHI, Tokyo (JP)

(73) Assignee: Mitsubishi Electric Corporation, Tokyo (JP)

(21) Appl. No.: 17/337,717

(22) Filed: Jun. 3, 2021

Related U.S. Application Data
(63) Continuation of application No. PCT/JP2019/002721, filed on Jan. 28, 2019.

(51) Int. Cl. G06F 11/36

(52) U.S. Cl. CPC G06F 11/3688; G06F 11/3692; G06F 11/3684

(57) ABSTRACT

A test device (100) runs an application program (111) that performs a series of function call processes utilizing a software platform (106), thereby testing the software platform (106). A log acquisition unit (201) runs the application program (111) a plurality of times repeatedly so as to acquire a trace log (113) including a plurality of trace results obtained by tracing the series of function call processes. A log analysis unit (202) analyzes the trace log (113) so as to estimate, as a variable attribute, each of an attribute of an argument and an attribute of a return value, of a function called by the series of function call processes. A program generation unit (203) generates a simulation program (303) which simulates the series of function call processes, using the variable attribute.

### CROSS REFERENCE TO RELATED APPLICATION

This application is a Continuation of PCT International Application No. PCT/JP2019/002721, filed on Jan. 28, 2019, which is hereby expressly incorporated by reference into the present application.

### TECHNICAL FIELD

The present invention relates to a test device, a test method, and a test program.

### BACKGROUND ART

A quality of a conventional software platform is guaranteed by a unit test or system test with an Application Programming Interface (API) which is to be provided to an application program. A specific example of the software platform is an Operating System (OS) or a library. Such software platform is tested based on a test case that anticipates a call from the application program.

Patent Literature 1 or Patent Literature 3 proposes a technique of comparing, when a platform is modified, a trace log of an application program before the modification and a trace log of an application program after the modification, so that prediction of a degraded portion of the application program is facilitated.

Patent Literature 2 proposes a technique of expanding test cases to include a unit of processing for a user side, storing a history of processing, and enabling re-run of the test, so that platform defect verification on the user side is facilitated.

Patent Literature 4 proposes a technique of acquiring a user operation and reproducing the user operation a plurality of times, so that a regression test of a platform is run at a high speed.

Patent Literature 5 proposes a technique of, upon occurrence of a failure, tracing hardware information, converting trace data to have a format associated with a simulator, and reproducing the trace data by the simulator, so that debugging, verification, or optimization is enabled. The hardware information is information such as an instruction decoder, a cache, and a register.

Patent Literature 6 proposes a technique according to which an application at an upper layer and a dependent library analyze a function call on a debugging-target library, so that debugging is facilitated.

### CITATION LIST

### Patent Literature

Patent Literature 1: JP H10-320234 A

Patent Literature 2: JP H11-119956 A

Patent Literature 3: WO2012/127729

Patent Literature 4: JP 2015-169975 A

Patent Literature 5: JP 2013-531292 A

Patent Literature 6: JP 2007-080036 A

### SUMMARY OF INVENTION

### Technical Problem

In the prior art, it is difficult to entirely grasp in what order an application program calls APIs of a library. Therefore, in the prior art, when performing combination testing of a plurality of libraries, an actual call order by the application program cannot be specified, and an omission from the testing occurs. Further, in a multi-threaded or multi-core environment, since the API call order changes each time the application program runs, the running order becomes complicated, and static analysis cannot be performed, which makes the testing further difficult. Even if an actual call order can be assumed, the application may be updated frequently, so it takes time to generate a simulation test program to track the test. This results in a problem of a high maintenance cost.

An objective of the present invention is to efficiently and highly accurately generate a simulation program that matches a range of use of an application program.

### Solution to Problem

A test device according to the present invention runs an application program that performs a series of function call processes utilizing a software platform, thereby testing the software platform, the test device comprising:

a log acquisition unit to run the application program a plurality of times repeatedly so as to acquire a trace log including a plurality of trace results obtained by tracing the series of function call processes, the tracing results including an argument and a return value, of a function called by the series of function call processes;

a log analysis unit to analyze the trace log so as to estimate, as a variable attribute, each of an attribute of the argument and an attribute of the return value, of the function called by the series of function call processes; and

a program generation unit to generate a simulation program which simulates the series of function call processes using the variable attribute.

### Advantageous Effects of Invention

In a test device according to the present invention, a log acquisition unit runs an application program a plurality of times repeatedly to acquire a trace log including a plurality of trace results obtained by tracing a series of function call processes. A log analysis unit analyzes the trace log to estimate a variable attribute of each of an argument and a return value, of a function which is called by the series of function call processes. A program generation unit generates a simulation program that simulates the series of function call processes, using the variable attribute. Therefore, with the test device according to the present invention, it is possible to efficiently and highly accurately generate a simulation program that matches a range of use of the application program.

### BRIEF DESCRIPTION OF DRAWINGS

FIG. 1 is a hardware configuration diagram of a test device according to Embodiment 1.

FIG. 2 is a facility configuration diagram of the test device according to Embodiment 1.

FIG. 3 is a flowchart of software test processing of a comparative example of Embodiment 1.

FIG. 4 is a flowchart illustrating operations of a log acquisition unit according to Embodiment 1.

FIG. 5 presents an example of a trace log according to Embodiment 1.

FIG. 6 is a flowchart illustrating operations of a log analysis unit according to Embodiment 1.

FIG. 7 presents an example of a variable attribute tag according to Embodiment 1.

FIG. 8 presents an example of a function call table according to Embodiment 1.

FIG. 9 is a flowchart illustrating operations of a program generation unit according to Embodiment 1.

FIG. 10 is a flowchart illustrating operations of a result judging unit according to Embodiment 1.

FIG. 11 presents an example of a function call test list according to Embodiment 1.

FIG. 12 presents an example of a function call table according to Embodiment 2.

FIG. 13 is a flowchart illustrating operations of a log analysis unit according to Embodiment 2.

FIG. 14 is a flowchart illustrating operations of a program generation unit according to Embodiment 2.

FIG. 15 is a flowchart illustrating operations of a result judging unit according to Embodiment 2.

FIG. 16 is a flowchart illustrating operations of a log acquisition unit according to Embodiment 3.

FIG. 17 is a flowchart illustrating operations of a log analysis unit according to Embodiment 3.

FIG. 18 is a flowchart illustrating operations of a log acquisition unit according to Embodiment 4.

### DESCRIPTION OF EMBODIMENTS

Embodiments of the present invention will be described below with referring to drawings. In the drawings, the same or equivalent portion is denoted by the same reference sign. In the description of the embodiments, the same or equivalent portion will appropriately be omitted, or described briefly.

### Embodiment 1

### Description of Configurations

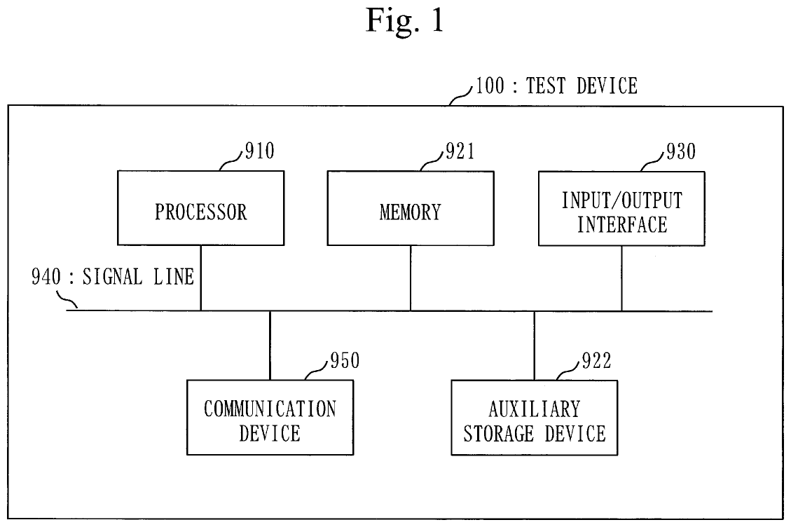

FIG. 1 is a diagram illustrating a hardware configuration of a test device 100 according to the present embodiment.

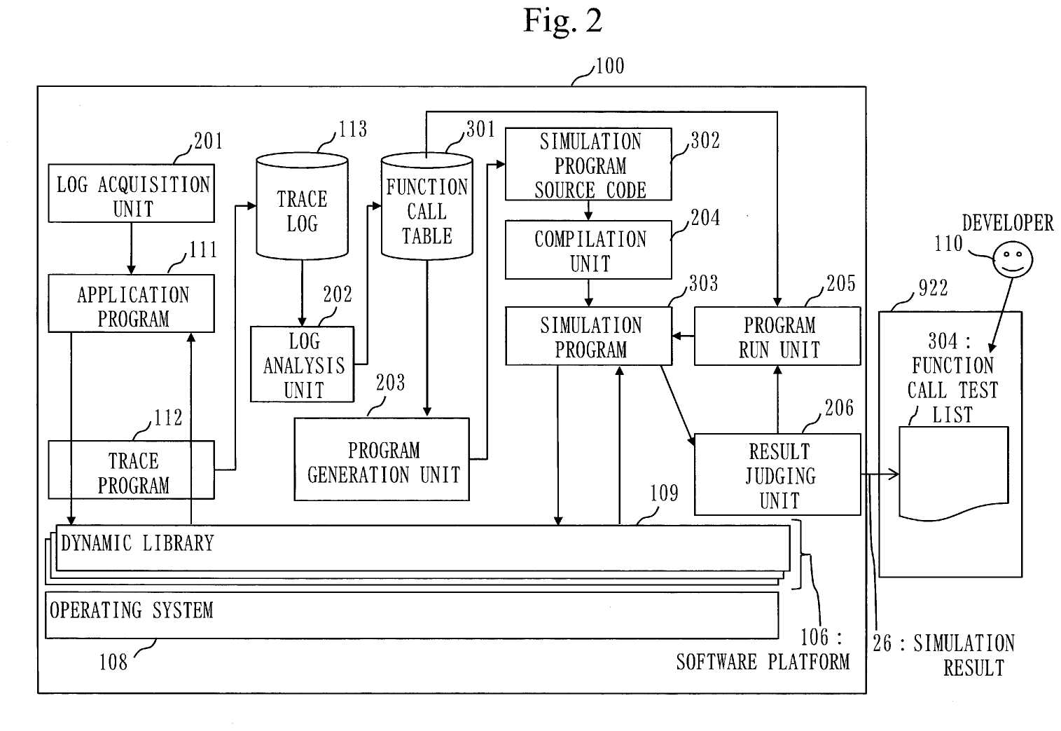

FIG. 2 is a diagram illustrating a facility configuration of the test device 100 according to the present embodiment.

The test device 100 is a computer. The test device 100 is provided with a processor 910, and other hardware devices such as a memory 921, an auxiliary storage device 922, an input/output interface 930, and a communication device 950.

The processor 910 is connected to the other hardware devices via a signal line 940 and controls the other hardware devices.

The test device 100 is provided with a log acquisition unit 201, a log analysis unit 202, a program generation unit 203, a compilation unit 204, a program running unit 205, and a result judging unit 206, as facility elements.

Facilities of the log acquisition unit 201, log analysis unit 202, program generation unit 203, compilation unit 204, program running unit 205, and result judging unit 206 are implemented by software.

The processor 910 is a device that runs a test program. The test program is a program that implements the facilities of the log acquisition unit 201, log analysis unit 202, program generation unit 203, compilation unit 204, program running unit 205, and result judging unit 206.

The processor 910 is an Integrated Circuit (IC) which performs computation processing. Specific examples of the processor 910 include a Central Processing Unit (CPU), a Digital Signal Processor (DSP), and a Graphics Processing Unit (GPU).

The memory 921 is a storage device which stores data temporarily. A specific examples of the memory 921 is a Static Random-Access Memory (SRAM) or a Dynamic Random-Access Memory (DRAM).

The auxiliary storage device 922 is a storage device which keeps data. Specific examples of the auxiliary storage device 922 include an HDD. Alternatively, the auxiliary storage device 922 may be a portable recording medium such as an SD (registered trademark) memory card, a CF, a NAND flash, a flexible disk, an optical disk, a compact disk, a Blu-ray (registered trademark) Disc, and a DVD. Note that HDD stands for Hard Disk Drive, SD (registered trademark) stands for Secure Digital, CF stands for CompactFlash (registered trademark), and DVD stands for Digital Versatile Disk.

The input/output interface 930 is provided with, as an input interface, a port to be connected to an input device such as a mouse, a keyboard, and a touch panel. The input interface is specifically a Universal Serial Bus (USB) terminal. Alternatively, the input interface may be a port to be connected to a Local Area Network (LAN).

The input/output interface 930 is also provided with, as an output interface, a port to which a cable of an output device such as a display is to be connected. The output interface is specifically a USB terminal or a High-Definition Multimedia Interface (HDMI; registered trademark) terminal. The display is specifically a Liquid Crystal Display (LCD).

The communication device 950 communicates with the other devices via a network. The communication device 950 has a receiver and a transmitter. The communication device 950 is connected to a communication network such as a LAN, the Internet, and a telephone line, via wireless connection. The communication device 950 is specifically a communication chip or a Network Interface Card (NIC).

The test program is read by the processor 910 and run by the processor 910. Not only the test program but also an Operating System (OS) is stored in the memory 921. The processor 910 runs the test program while running the OS. The test program and the OS may be stored in the auxiliary storage device 922. The test program and the OS which are stored in the auxiliary storage device 922 are loaded in the memory 921 and run by the processor 910. The test program may be incorporated in the OS partly or entirely.

The test device 100 may be provided with a plurality of processors that substitute for the processor 910. The plurality of processors share run of the test program. Each processor is a device that runs the test program just as the processor 910 does.

Data, information, signal values, and variable values which are utilized, processed, or outputted by the test program are stored in the memory 921, the auxiliary storage device 922, or a register or cache memory in the processor 910.

The term “unit” in each of the log acquisition unit 201, the log analysis unit 202, the program generation unit 203, the compilation unit 204, the program running unit 205, and the result judging unit 206 may be read as “process”, “procedure”, or “stage”.

The test program causes the computer to run a log acquisition process, a log analysis process, a program generation process, a compilation process, a program running process, and a result judging process. A test method is a method that is performed by the test device 100 running the test program.

The test program may be stored in a computer-readable storage medium and presented as the storage medium. The test program may be presented as a program product.

### Description of Facility Outline

The test device 100 runs an application program 111 that performs a series of function call processes utilizing a software platform 106, thereby testing the software platform 106.

As illustrated in FIG. 2, an operating system 108 operates in the test device 100, and a dynamic library 109 operates above the operating system 108. The software platform 106 is specifically the dynamic library 109. There may be a plurality of dynamic libraries. The application program 111 operates above the plurality of dynamic libraries. The application program 111 is information processing such as display processing, sound processing, database processing, WEB application processing, and calculation processing. A trace program 112 is a program that hooks a function call being made on the dynamic library 109 by the application program 111, and outputs the hooked function call to a trace log 113. The trace log 113 is outputted to the memory 921 or the auxiliary storage device 922.

The log acquisition unit 201 runs the application program 111 and the trace program 112. The log acquisition unit 201 uses the trace program 112 to output the function call on the dynamic library 109 in the application program 111, to the trace log 113.

The log analysis unit 202 analyzes the trace log 113 statistically, corrects a value of the trace log 113 to enable re-run, and outputs the corrected trace log 113 to a function call table 301. “Corrects a value of the trace log 113” signifies a process of attaching a variable attribute tag to each of an argument and return value of a function, as will be described later.

In the function call table 301, a tag for each variable type such as a random number, time point, a system variable, and an address is stored as the argument of the function. As the return value, for example, a borrowed portion which is borrowed in another function is stored.

The program generation unit 203 reads the function call table 301 and generates a simulation program source code 302.

The compilation unit 204 compiles the simulation program source code 302 and generates a runnable simulation program 303.

The program running unit 205 runs the simulation program 303. The simulation program 303 calls the dynamic library 109 and outputs a simulation result 26 of the dynamic library 109. The output destination is the memory 921 or the auxiliary storage device 922.

The result judging unit 206 requests the program running unit 205 to run the simulation program 303, compares the simulation result 26 of the simulation program 303 with the function call table 301, and outputs a result to a function call test list 304.

An expectation value of an output expected in the simulation program 303, and a judgment result are stored in the function call test list 304. The expectation value is decided in advance based on the variable type of the function call table 301 or the borrowed portion. A developer 110 checks the function call test list 304 and judges whether the dynamic library 109 has conducted an expected operation.

### Description of Operations

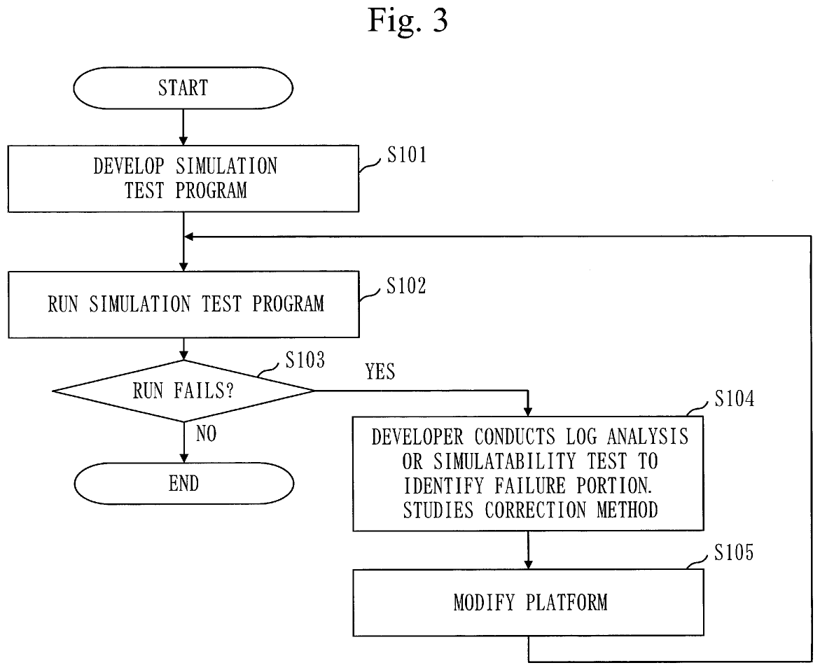

First, a flow of software test processing of a comparative example for comparison with the present embodiment will be described with referring to FIG. 3.

In step S101, a simulation test program is developed.

In step S102, the simulation test program is run.

In step S103, whether the run is successful or not is judged. If the run is successful, the processing ends.

If the run fails, then in step S104, the developer conducts log analysis or a simulatability test, and a failure portion is identified. The developer also studies a correction method.

In step S105, the platform is modified.

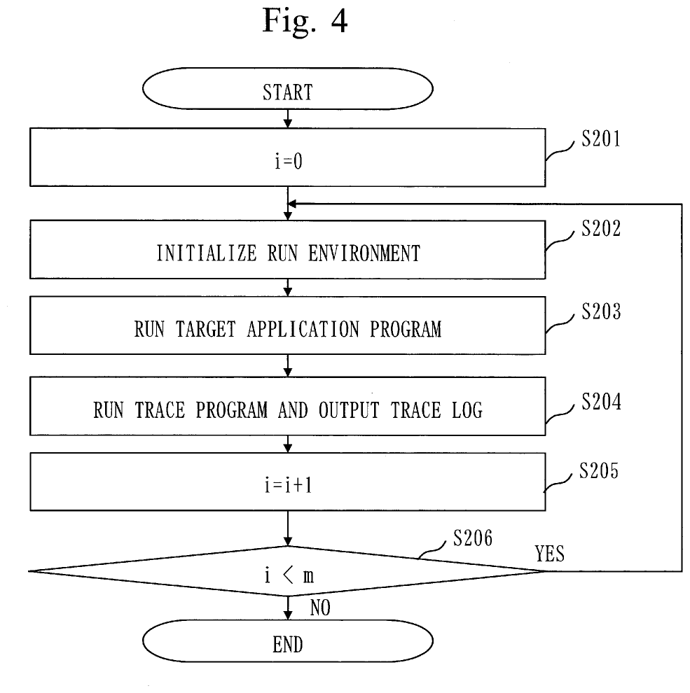

Operations of test process S100 according to the present embodiment will now be described with referring to FIGS. 4 to 11.

<Log Acquisition Process>

FIG. 4 is a flowchart illustrating operations of the log acquisition unit 201 according to the present embodiment.

In the log acquisition process, the log acquisition unit 201 runs the application program 111 a plurality of times repeatedly to acquire the trace log 113 including a plurality of trace results 13. The trace results 13 are a result obtained by tracing a series of function call processes 333. The trace results 13 include an argument and return value of a function called by the series of function call processes 333.

In step S201, the log acquisition unit 201 initializes a log acquisition count i.

In step S202, the log acquisition unit 201 initializes a run environment. Initialization of the run environment is a preprocess such as deletion of a preset file or a shared memory.

In step S203, the log acquisition unit 201 runs the application program 111 being a target from which the trace log 113 is acquired.

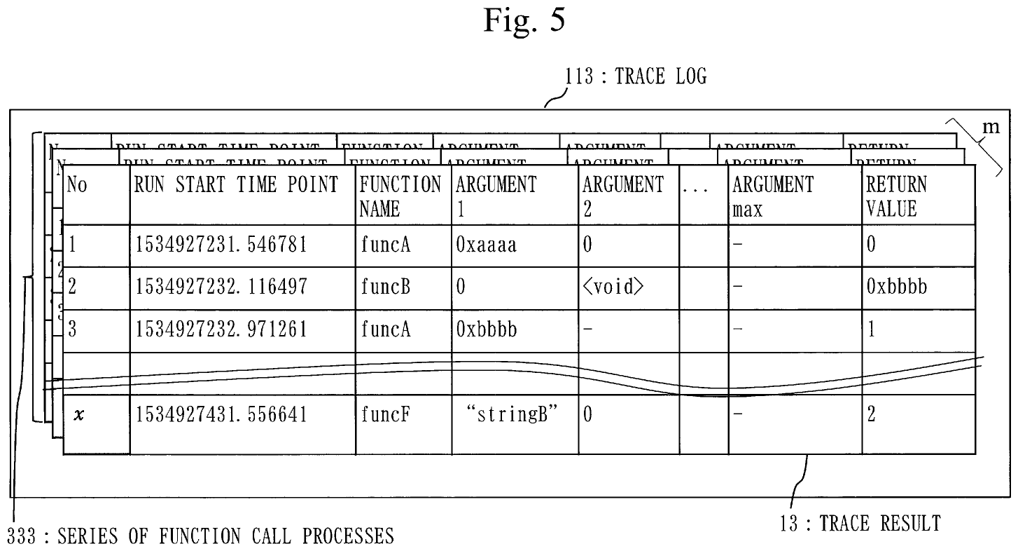

In step S204, the log acquisition unit 201 runs the trace program 112, specifies the application program 111 which is run in step S203, and outputs the trace log 113 of FIG. 5.

FIG. 5 is a diagram illustrating an example of the trace log 113 according to the present embodiment.

The log acquisition unit 201 hooks, with the trace program 112, a call being made on the dynamic library by the application program 111, and outputs a run start time point, a function name, an argument, and a return value. The log acquisition unit 201 acquires arguments ranging from argument 1 to argument max. An argument beyond the acquired arguments is expressed by “-”. The argument max is decided in advance. Data such as a call of a system call, which is other than those mentioned above, may be appended to the trace log 113. Such data must have a format that allows distinction from a call on the dynamic library. The run start time point may have any format as far as each run start time point can be subjected to comparative computation with another run start time point and from which absolute time point can be grasped. For example, the run start time point may have a format such as UNIX (registered trademark) time. The argument and the return value are a model name and a value. The model name is, for example, an address, a character string, an integer, a decimal number, NULL, or void. The argument and the return value may include one that can refer to a memory map related to run of the application. One that can refer to the memory map is, for example, if a pointer of a structure is concerned, a member variable name of the structure and a value of the member variable name; and if an array is concerned, data such as every array data.

In step S205, the log acquisition unit 201 increments the log acquisition count i by 1.

In step S206, if the log acquisition count i is equal to m or more, the log acquisition unit 201 ends the processing; if i is less than m, the log acquisition unit 201 returns to step S202. Note that m is decided in advance and may take any value equal to 1 or more.

<Log Acquisition Process>

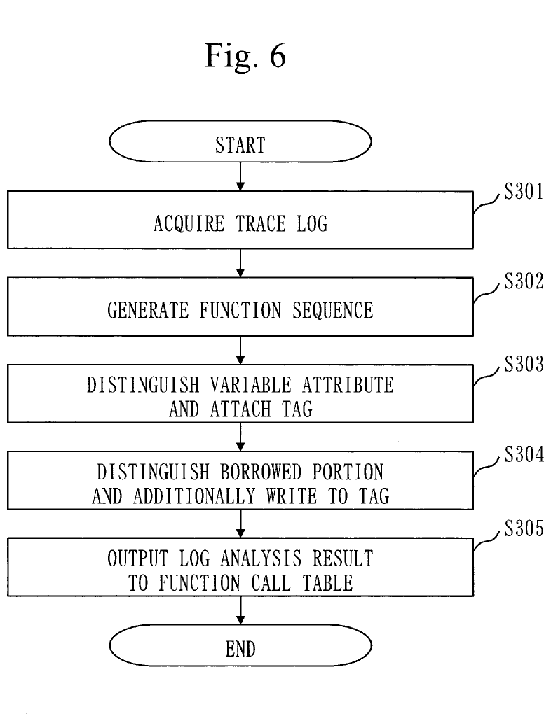

FIG. 6 is a flowchart illustrating operations of the log analysis unit 202 according to the present embodiment.

The log analysis unit 202 analyzes the trace log 113 so as to estimate, as a variable attribute 21, each of an attribute of an argument and an attribute of a return value, of a function called by the series of function call processes 333. The log analysis unit 202 generates the function call table 301 in which the argument and return value of the function called by the series of function call processes 333 are each attached with a variable attribute tag 208 indicating the variable attribute 21.

In step S301, the log analysis unit 202 acquires the trace log 113 from the memory 921 or the auxiliary storage device 922.

In step S302, the log analysis unit 202 generates, as the series of function call processes 333, a function sequence from the trace log 113. Specifically, when the trace log 113 of FIG. 5 is concerned, the log analysis unit 202 generates a function sequence (funcA, funcB, funcA, . . . , funcF) of No1 to Nox.

In step S303, the log analysis unit 202 analyzes the trace log 113 statistically to estimate the variable attribute 21. The log analysis unit 202 analyzes the trace log 113 statistically to estimate, as the variable attribute 21, a variable type 211 which expresses a type of each of the argument and return value, of the function called by the series of function call processes 333. Also, the log analysis unit 202 analyzes the trace log 113 statistically to estimate, as the variable attribute 21, a borrowed portion where the argument and return value of the function called by the series of function call processes 333 are borrowed.

Specifically, the log analysis unit 202 analyzes statistically a function sequence of m pieces of trace results 13, and arguments and return values that match the function sequence. If variables in the functions of the same sequence are different among all of the m pieces of trace results 13, the log analysis unit 202 estimates that the variables are random numbers. The log analysis unit 202 also estimates that a variable that is similar to a difference in run time point in the same function between a preceding trace log and a subsequent trace log expresses time point. In this manner, based on the m pieces of trace results 13, the log analysis unit 202 estimates the variable attribute 21 from information such as a change in variable of the same function, and tags the variable attribute 21 to the individual argument and the individual return value.

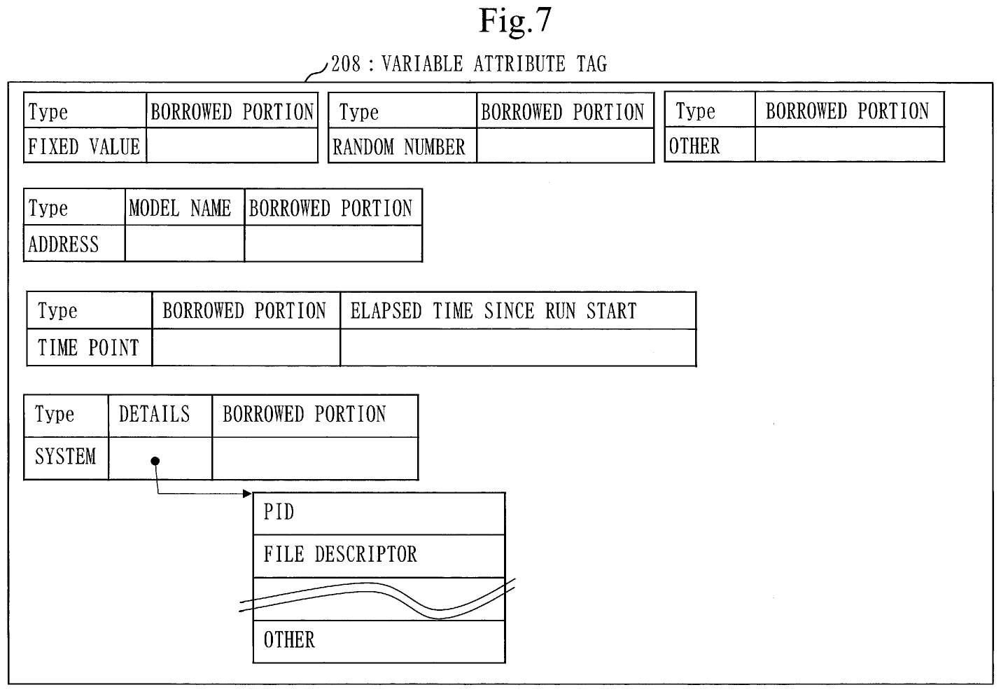

FIG. 7 presents an example of the variable attribute tag 208 according to the present embodiment.

The variable attribute tag 208 is a tag of a variable and a return value. The variable attribute tag 208 is stored in the memory 921 or the auxiliary storage device 922 in advance.

The log analysis unit 202 analyzes m pieces of communication sequences statistically, estimates which variable attributes of FIG. 7 a variable attribute of an individual argument and a variable attribute of an individual return value, of each communication sequence correspond to, and tags the corresponding variable attributes to that argument and to that return value. When Type of a variable attribute is a system, a function name and an argument type of the system library are saved in advance. If the stored function name coincides with a function name of the function sequence, it is distinguished that the argument whose type is stored is the argument of that function. For example, if the function name is getpid, it is distinguished that the return value is PID. The system library may be any library as far as it is a wrapper function of a system call of the operating system. For example, the system library is a glibc function, a Newlib function, or the like of a C standard library.

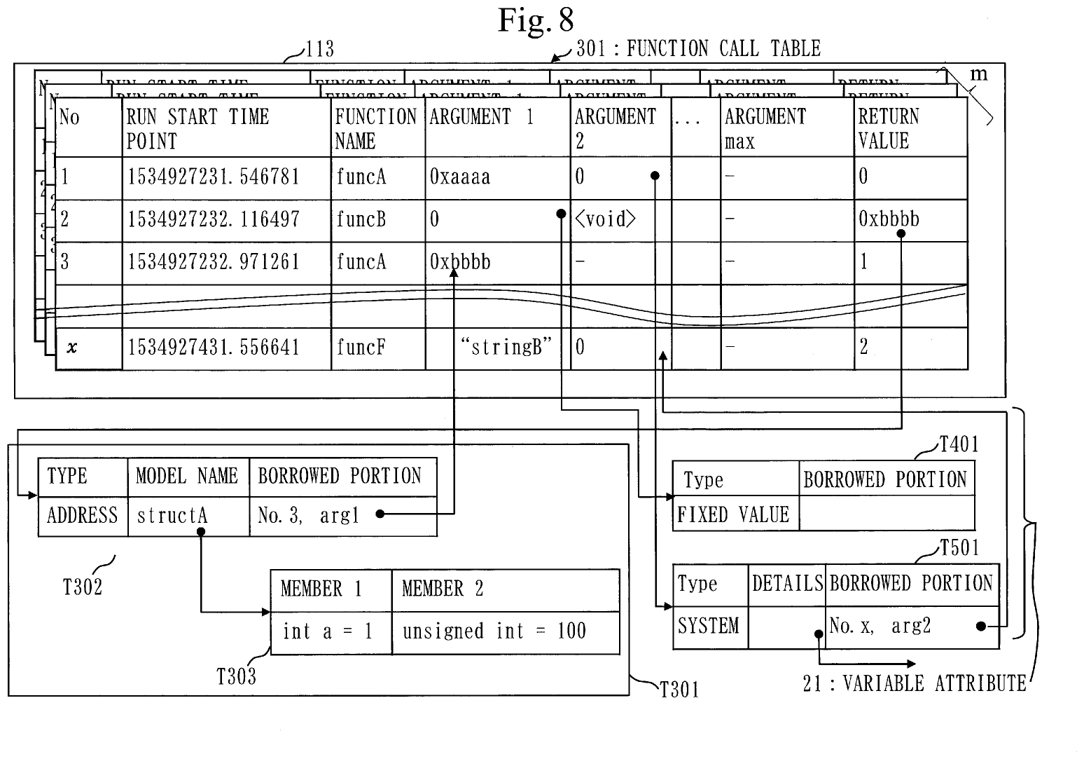

FIG. 8 presents an example of the function call table 301 according to the present embodiment.

The function call table 301 is a table in which all arguments and all return values of the trace log 113 are each tagged with a statistically analyzed variable attribute 21.

If the address has a structure, the log analysis unit 202 tags a member variable and a value of the member variable to the address, as indicated with variable attribute T301 of FIG. 8. Member 1 and member 2 each signify a member of a structure structA of variable attribute T302. Data acquired by the log acquisition unit 201 is tagged as is, to each of member 1 and member 2.

Variable type T401 is an example where Type is a “fixed value”. Variable type T501 is an example where Type is a “system”.

In step S304, the log analysis unit 202 judges whether or not the arguments and the return values in subsequent functions are also borrowed. If borrowed, the log analysis unit 202 additionally writes the borrowed information to the tag. For example, as illustrated in FIG. 8, if return value 0xbbb of function funcB coincides with a value of an argument of next function funcA, and that this coincidence is observed in every trace log, it is judged that return value 0xbbbb of function funcB is borrowed.

In step S305, the log analysis unit 202 outputs analysis results up to step S304 to the function call table 301.

<Program Generation Process>

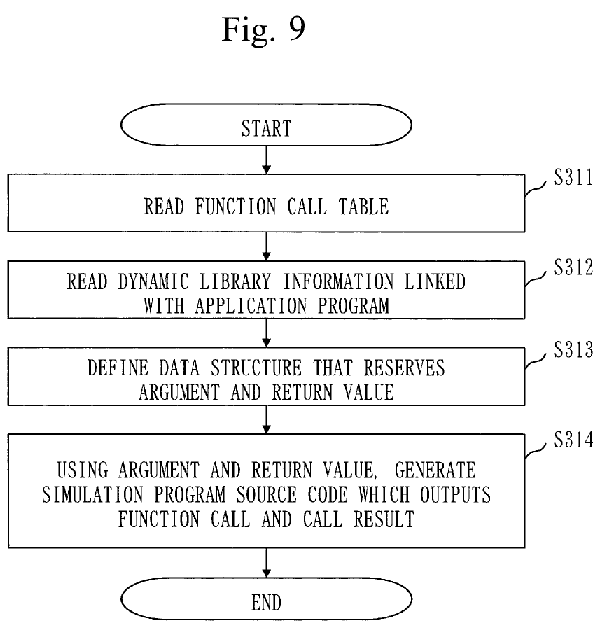

FIG. 9 is a flowchart illustrating operations of the program generation unit 203 according the present embodiment.

In a program generation process, the program generation unit 203 generates the simulation program 303 which simulates the series of function call processes 333, using the variable attribute 21. The program generation unit 203 generates the simulation program 303 using the function call table 301.

In step S311, the program generation unit 203 acquires the function call table 301.

In step S312, the program generation unit 203 reads dynamic library information linked with the application program 111. For example, the application program 111 includes a function name of the dynamic library. Information of the function called by the application program 111 is stored in the memory as the dynamic library information.

The dynamic library information may be any information as far as it enables identification of a variable name and a type. The dynamic library information may be information such as a header file. The header file signifies a header file necessary for linking the dynamic library. For example, when libc library is used in the C language, #include<stdio.h> is attached to the top of a source code. Note that stdio.h is the header file. If a variable name and a type (specifically a byte count) cannot be identified with the header file alone, they are identified by, for example, searching a file referred to by the header file.

In step S313, the program generation unit 203 defines a data structure and a variable that reserve an argument and a return value, using the dynamic library information read in step S312.

In step S314, the program generation unit 203 generates the simulation program source code 302 using the variable defined in step S312, so as to output function calls and a log of each function call. Function call time point, a function name, an argument type, and a value of a return value are outputted to the log. The log may have any format as far as it enables identification of an order of function calls uniquely.

The compilation unit 204 compiles the simulation program source code 302 to generate the simulation program 303. Also, cross compilation may be performed for the purpose of running in a different environment, and a subsequent run may be performed with a device different from the test device 100.

The program running unit 205 receives an instruction from the result judging unit 206 and runs the simulation program 303.

In this discussion, the program generation unit 203 generates the simulation program source code 302, and the compilation unit 204 generates the simulation program 303 from the simulation program source code 302. Alternatively, the program generation unit 203 may have a facility of generating the simulation program 303 from the simulation program source code 302.

<Result Judging Process>

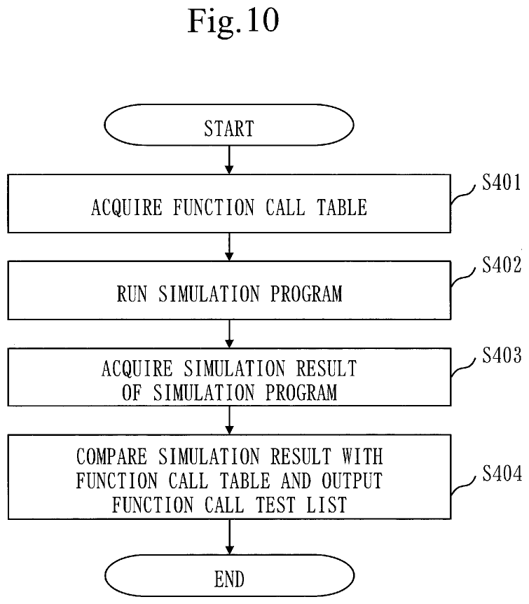

FIG. 10 is a flowchart illustrating operations of the result judging unit 206 according to the present embodiment. The result judging unit 206 is also called a simulation program output result judging unit which judges an output result of the simulation program 303.

The result judging unit 206 runs the simulation program 303, acquires, as the simulation result 26, the argument and return value of the function which is called by the series of function call processes 333, and judges whether the attribute of the simulation result 26 satisfies an expectation value.

In step S401, the result judging unit 206 acquires the function call table 301.

In step S402, the result judging unit 206 requests the program running unit 205 to run the simulation program 303. The program running unit 205 runs the simulation program 303.

In step S403, the result judging unit 206 acquires an output from the simulation program 303 as the simulation result 26.

In step S404, the result judging unit 206 compares the simulation result 26 of the simulation program 303 with an output result of an equivalent function in the function call table 301, and outputs a comparison result to the function call test list 304.

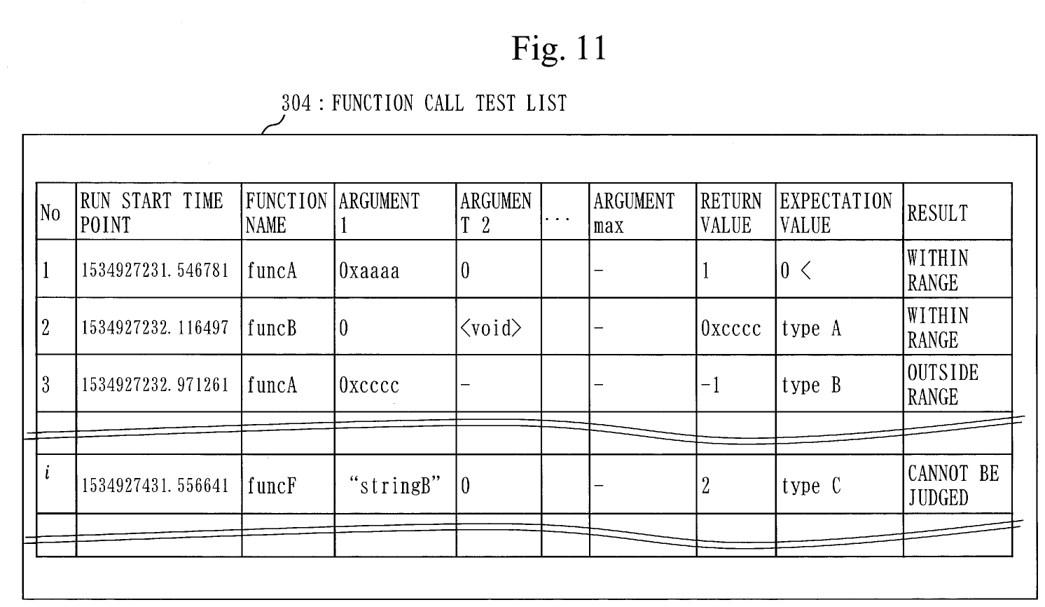

FIG. 11 presents an example of the function call test list 304 according to the present embodiment.

In the function call test list 304, an item of the expectation value of the return value and an item of the result are added to items of the trace log 113. The expectation value of the return value is obtained on the basis of the variable attribute 21 tagged to the function call table 301. Specifically, the test device 100 automatically sets the expectation value of the return value on the basis of the tag attached to the return value in step S303. For example, if the variable type is PID, a value equal to or more than 1 and equal to or less than a MAX value of PID of the system is set as the expectation value of the return value. If the variation type is address, for example, a value falling within a valid address range of the system is set as the expectation value of the return value. The result judging unit 206 compares the return value with the expectation value. If the return value falls within the range of the expectation value, the result judging unit 206 sets “within range” as the result. If the return value falls outside the range of the expectation value, the result judging unit 206 sets “outside range” as the result. If the type of the return value is, for example, “other” and cannot be identified, the result judging unit 206 sets “cannot be judged” as the result. The result judging unit 206 also judges a result for the return value on the basis of the tagged variable attribute.

### Other Configurations

In the present embodiment, the facilities of the log acquisition unit 201, log analysis unit 202, program generation unit 203, compilation unit 204, program running unit 205, and result judging unit 206 may be implemented by hardware.

The test device 100 is provided with an electronic circuit in place of the processor 910.

The electronic circuit is a dedicated electronic circuit that implements the facilities of the log acquisition unit 201, log analysis unit 202, program generation unit 203, compilation unit 204, program running unit 205, and result judging unit 206.

The electronic circuit is specifically a single circuit, a composite circuit, a programmed processor, a parallel-programmed processor, a logic IC, a GA, an ASIC, or an FPGA. Note that GA stands for Gate Array, ASIC stands for Application Specific Integrated Circuit, and FPGA stands for Field-Programmable Gate Array.

The facilities of the log acquisition unit 201, log analysis unit 202, program generation unit 203, compilation unit 204, program running unit 205, and result judging unit 206 may be implemented by one electronic circuit, or by a plurality of electronic circuit through distribution.

According to another modification, some facilities of the log acquisition unit 201, log analysis unit 202, program generation unit 203, compilation unit 204, program running unit 205, and result judging unit 206 may be implemented by an electronic circuit, and the remaining facilities may be implemented by software. Alternatively, some or all of the facilities of the log acquisition unit 201, log analysis unit 202, program generation unit 203, compilation unit 204, program running unit 205, and result judging unit 206 may be implemented by firmware.

The processor and the electronic circuit are called processing circuitry. That is, in the test device 100, the facilities of the log acquisition unit 201, log analysis unit 202, program generation unit 203, compilation unit 204, program running unit 205, and result judging unit 206 are implemented by processing circuitry.

### Description of Effect of Present Embodiment

As described above, with the test device 100 according to the present embodiment, library testing that matches a range of use of the application program can be performed by automatically generating a runnable simulation program. Hence, with the test device 100 according to the present embodiment, a quality of the software platform is improved.

Also, with the test device 100 according to the present embodiment, the simulation program is generated from the trace log that has been run a plurality of times within the range of use of the application program. Therefore, with the test device 100 according to the present embodiment, an optimum simulation program can be generated automatically, so the developer need not perform an operation of, for example, maintaining the simulation program in view of the result of the test. Hence, a maintenance cost of the simulation program can be reduced.

Also, with the test device 100 according to the present embodiment, since only a library call of the application program is simulated, a black box test of the application program can be realized. Hence, with the test device 100 according to the present embodiment, environment maintenance of, for example, a preset file necessary for running the application program becomes unnecessary. As a result, preparation work for running the test is reduced, and the test efficiency improves.

Also, with the test device 100 according to the present embodiment, how the application program calls an API of the library is traced a plurality of times, and a traced content is analyzed statistically. Hence, with the test device 100 according to the present embodiment, it is possible to generate a re-runnable simulation program automatically by identifying a process, a type of a variable, or a borrowed variable that may differ in each run. Hence, the maintenance cost of the simulation program can be reduced, and a test that matches the range of use of the application program can be practiced a plurality of times repeatedly, so that the quality of the platform can be improved.

### Embodiment 2

In the present embodiment, differences from Embodiment 1 will be described. The same configuration as in Embodiment 1 will be denoted by the same reference sign, and its description will be omitted.

The test device 100 of Embodiment 1 automatically generates a runnable simulation program from a log obtained by tracing a plurality of times a library call being made by the application program. With the test device 100 of the present embodiment, when a processing flow of an application program differs in an individual trace, the processing flow is classified based on a similarity degree of a function sequence of the trace log. Then, the test device 100 generates a simulation program in units of classified processing flows.

### Description of Configurations

In the present embodiment, a hardware configuration and facility configuration of the test device 100 are the same as those of Embodiment 1, however, a plurality of simulation program source codes 302, a plurality of simulation programs 303, and a plurality of function call test lists 107 are used in the present embodiment.

A log acquisition unit 201 classifies a plurality of trace results 13 included in a trace log 113, as similar trace logs 132 based on an order of function calls included in each of the plurality of trace results, that is, based on a processing flow. A log analysis unit 202 estimates a variable attribute in units of similar trace logs 132. A program generation unit 203 generates a simulation program 303 in units of similar trace logs 132.

### Description of Operations

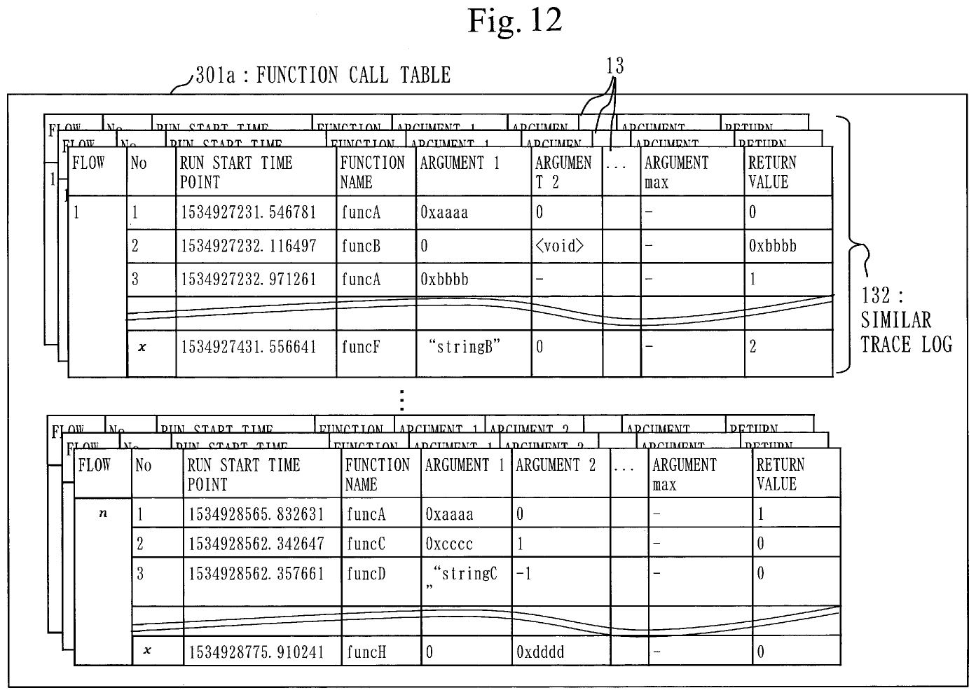

FIG. 12 presents an example of a function call table 301a according to the present embodiment.

In the function call table 301a, a processing flow item that classifies a processing flow is added to each trace result 13 of the function call table 301 of FIG. 8. Also, one trace result 13 is classified under one of processing flows 1, 2, . . . , n where n takes a value equal to or more than 1 and equal to or less than m.

Operations of the test device 100 according to the present embodiment are basically the same as those of Embodiment 1. The differences are as follows.

(1) The log analysis unit 202 classifies the plurality of trace results 13 of the trace log 113 in units of processing flows and generates the function call table 301a formed of the similar trace logs 132.
(2) The program generation unit 203 generates the simulation program source code 302 in units of similar trace logs 132 of the function call table 301a.
(3) A compilation unit 204 compiles the plurality of simulation program source codes 302 and generates the plurality of simulation programs 303.
(4) A result judging unit 206 runs the simulation program 303 generated in units of similar trace logs 132 and outputs a plurality of function call test lists 304 in units of similar trace logs 132.

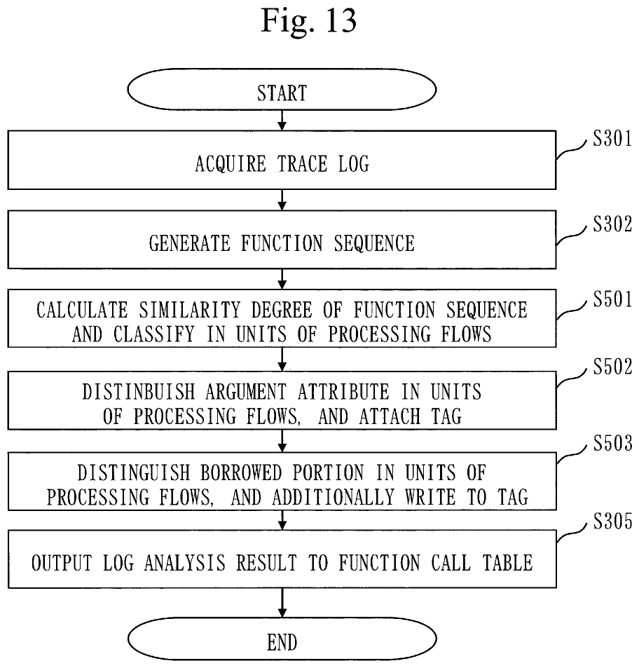

FIG. 13 is a flowchart illustrating operations of the log analysis unit 202 according to the present embodiment.

Step S301, step S302, and step S305 of FIG. 13 are the same as those in FIG. 6 of Embodiment 1.

In step S501, the log analysis unit 202 calculates similarity degrees of the function sequences of the trace results 13, and classifies the function sequences of the trace results 13 into n groups. The plurality of trace results 13 are classified under the similar trace log 132.

In step S502, the log analysis unit 202 performs the same process as that of step S303 in units of classified similar trace logs 132.

In step S503, the log analysis unit 202 performs the same process as that of step S304 in units of classified similar trace logs 132.

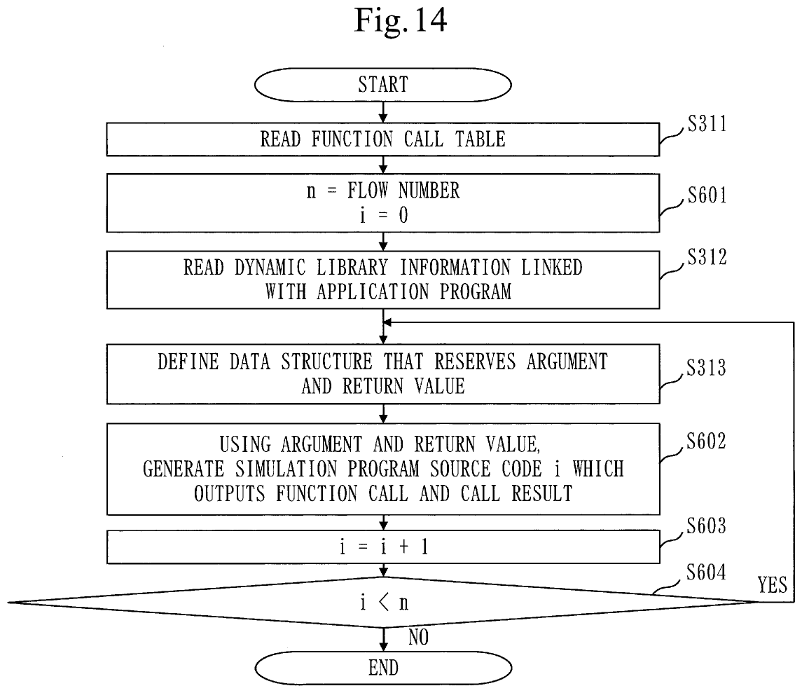

FIG. 14 is a flowchart illustrating operations of the program generation unit 203 according to the present embodiment.

Step S311, step S312, and step S313 of FIG. 14 are the same as those in FIG. 9 of Embodiment 1.

In step S601, the program generation unit 203 sets a processing flown.

In step S602, the program generation unit 203 generates a simulation program source code i added with a processing flow number.

In step S603, the program generation unit 203 sets a next processing flow number as i.

In step S604, if the processing flow number i is less than the processing flown, the program generation unit 203 branches the processing to step S313; if the processing flow number i is equal to or more than the processing flow n, the program generation unit 203 ends the processing.

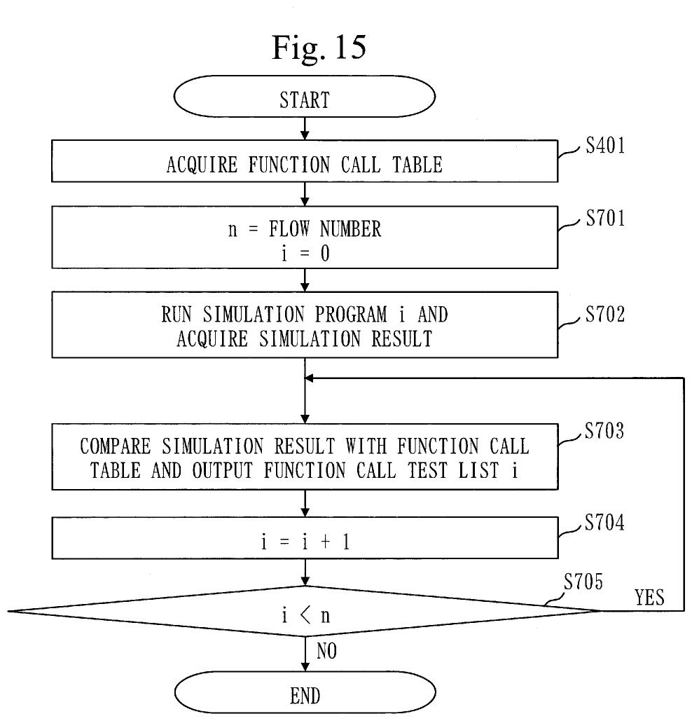

FIG. 15 is a flowchart illustrating operations of the result judging unit 206 according to the present embodiment.

Step S401 of FIG. 15 is the same as that in FIG. 10 of Embodiment 1.

In step S701, the result judging unit 206 sets the processing flown.

In step S702, the result judging unit 206 runs a simulation program i corresponding to the processing flow number i, and acquires a call result.

In step S703, the result judging unit 206 outputs a function call test list i corresponding to the processing flow number i.

In step S704, the result judging unit 206 sets i to a next processing flow number.

In step S705, if the processing flow number i is less than the processing flown, the result judging unit 206 branches the processing to step S702; if the processing flow number i is equal to or more than the processing flown, the result judging unit 206 ends the processing.

### Description of Effect of Present Embodiment

As described above, with the test device 100 according to the present embodiment, library testing can be performed in units of processing flows, being different from each other, of the application program. Hence, by library testing with a plurality of patterns, a bug and vulnerability that are difficult to find can be verified efficiently, so that a quality of a platform of the software improves.

### Embodiment 3

In the present embodiments, differences from Embodiment 1 or 2 will be described. The same configuration as that in Embodiment 1 or 2 will be denoted by the same reference sign, and its description will be omitted.

The test device 100 of Embodiment 2 automatically generates a runnable simulation program based on a log obtained by tracing a plurality of times a library call being made by the application program. In Embodiment 2, however, a time interval since the last trace of the application program is not decided. When statistically analyzing the trace log, sometimes processing dependent on time point is performed, for example, some processing starts based on absolute time point. In the present embodiment, a processing flow is classified effectively by using fixed-cyclic properties of run start time point of the application program.

### Description of Configurations

In the present embodiment, a hardware configuration and facility configuration of a test device 100 are the same as those of Embodiment 1.

A log acquisition unit 201 runs an application program 111 a plurality of times repeatedly at a run-regulating interval which expresses an interval of run of the application program.

### Description of Operations

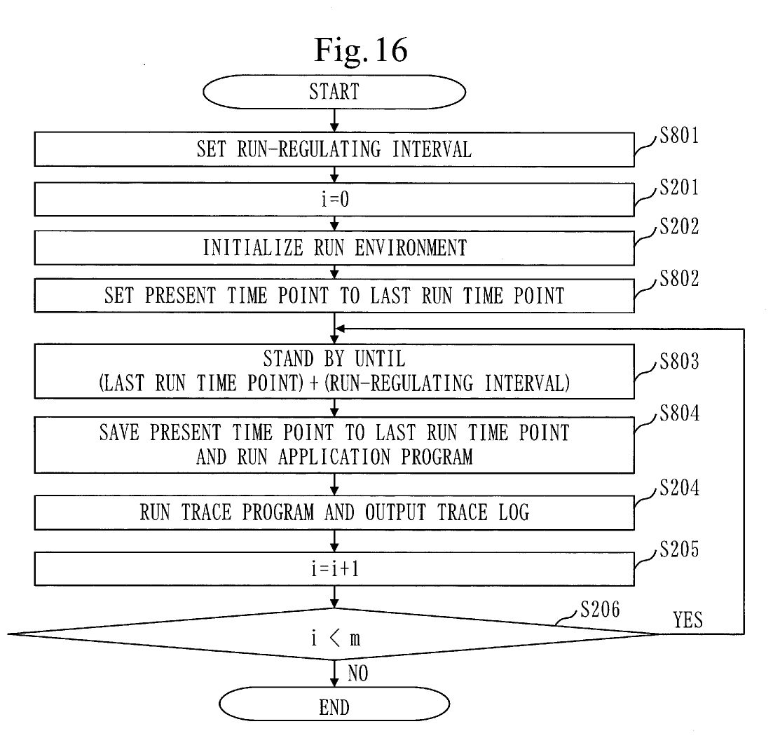

FIG. 16 is a flowchart illustrating operations of the log acquisition unit 201 according to the present embodiment.

Step S201, step S202, step S204, step S205, and step S206 of FIG. 16 are the same as those in FIG. 4 of Embodiment 1.

In step S801, the log acquisition unit 201 sets a run-regulating interval T. The run-regulating interval T may take any value equal to or more than 0.

In step S802, the log acquisition unit 201 sets present time point to last run time point.

In step S803, the log acquisition unit 201 stands by until time point obtained by adding the run-regulating interval T to the last run time point.

In step S804, the log acquisition unit 201 saves present time point which is wake-up time point, as last run time point, and runs the application program 111.

From the above, the log acquisition unit 201 can run the application program 111 at the run-regulating time interval T which is set in step S801.

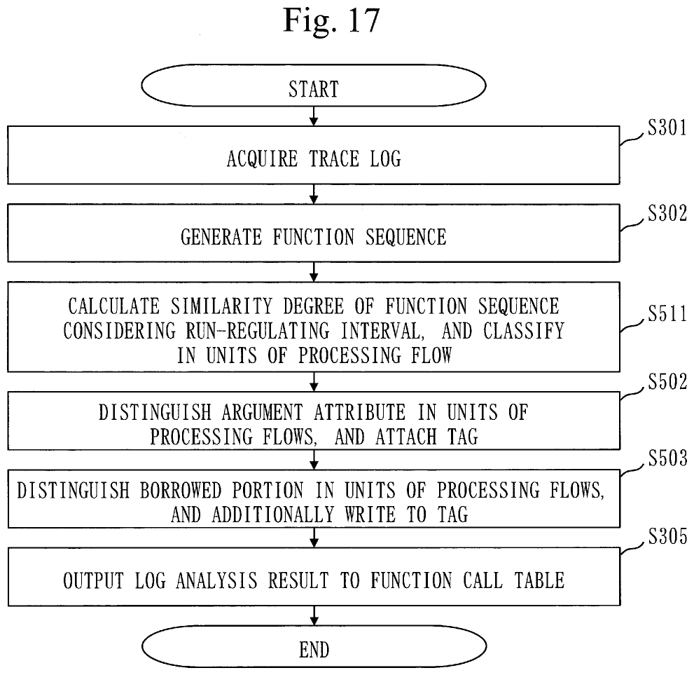

FIG. 17 is a flowchart illustrating operations of the log analysis unit 202 according to the present embodiment.

Step S301, step S302, step S502, step S503, and step S305 of FIG. 17 are the same as those in FIG. 13 of Embodiment 2.

In step S511, a log analysis unit 202 classifies a processing flow considering the run-regulating interval T. Specifically, the log analysis unit 202 performs the processing as follows. For example, even if the function sequence is similar, the log analysis unit 202 judges that the processing flow is a different processing flow if function run time point is different from what is assumed from the run-regulating interval T, and interprets the function sequence as a different sequence.

### Description of Effect of Present Embodiment

With the test device 100 according to the present embodiment, processing flow classification accuracy can be improved, and runnability of the simulation program can be enhanced.

### Embodiment 4

In the present embodiment, differences from Embodiment 1, 2, or 3 will be described. The same configuration as in Embodiment 1, 2, or 3 will be denoted by the same reference sign, and its description will be omitted.

The test device of Embodiment 1 generates a runnable program automatically from a log obtained by tracing, a plurality of times, a library call being made by the application program. When the application program runs, possibly a status of the platform may change, and accordingly an environmental condition of the trace may be different. In view of this, the test device 100 of the present embodiment makes the environmental condition identical by restarting the platform each time tracing is performed. This facilitates trace log analysis.

### Description of Configuration

In the present embodiment, a hardware configuration and facility configuration of a test device 100 are the same as those of Embodiment 1.

A log acquisition unit 201 initializes a software platform each time an application program 111 is run.

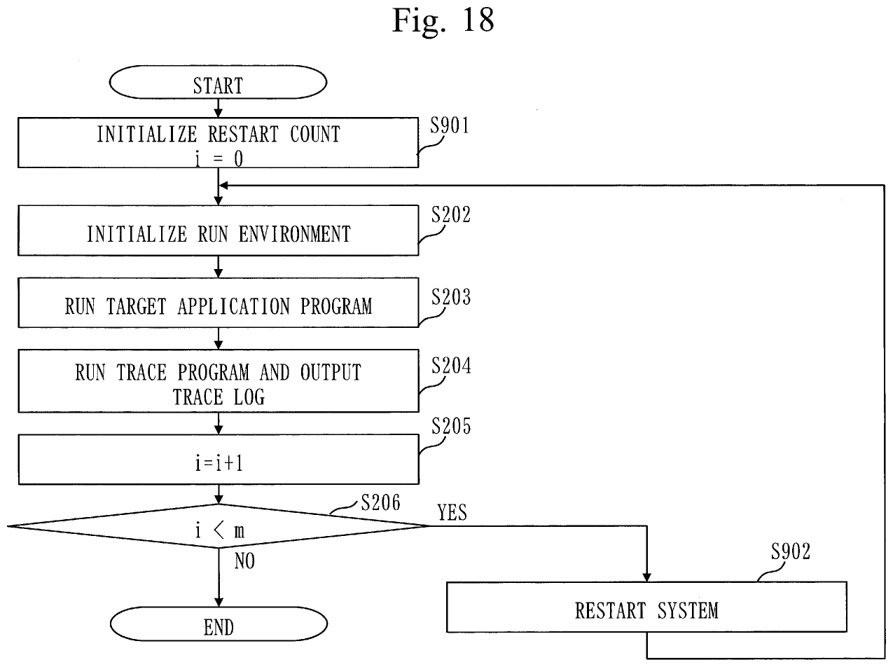

FIG. 18 is a flowchart illustrating operations of the log acquisition unit 201 according to the present embodiment.

Step S202, step S203, step S204, step S205, and step S206 in FIG. 18 are the same as those in FIG. 4 of Embodiment 1.

In step S901, the log acquisition unit 201 initializes a restart count.

In step S902, if the restart count is smaller than a trace log acquisition count, the log acquisition unit 201 performs restart. The log acquisition unit 201 instructs an operating system 108 to restart.

When the restart count reaches or exceeds the trace log acquisition count, the log acquisition unit 201 ends. These running status management operations may be performed by any method according to which the running status is held by restart.

### Description of Effect of Present Embodiment

With the test device according to the present embodiment, the operating environment of the application program can be made identical. Then, similarities among a plurality of trace logs increase, and the analysis accuracy improves.

In above Embodiments 1 to 4, each unit of the test device is described as an independent facility block. However, a configuration of a test device need not have the configuration as in the above embodiments. A facility block of the test device may have any configuration as far as it can implement the facility explained in the above embodiments.

Of Embodiments 1 to 4 described above, a plurality of portions may be practiced in combination. Alternatively, of these embodiments, one portion may be practiced. Furthermore, these embodiments may be practiced entirely or partly by any combination.

The embodiments described above are essentially preferable exemplifications and are not intended to limit the scope of the present invention, the scope of an applied product of the present invention, and the scope of usage of the present invention. Various changes can be made in the above embodiments where necessary.

### REFERENCE SIGNS LIST

100: test device; 13: trace result; 21: variable attribute; 26: simulation result; 106: software platform; 108: operating system; 109: dynamic library; 110: developer; 111: application program; 112: trace program; 113: trace log; 132: similar trace log; 201: log acquisition unit; 202: log analysis unit; 203: program generation unit; 204: compilation unit; 205: program running unit; 206: result judging unit; 208: variable attribute tag; 301, 301a: function call table; 302: simulation program source code; 303: simulation program; 304: function call test list; 333: series of function call processes; 910: processor; 921: memory; 922: auxiliary storage device; 930: input/output interface; 940: signal line; 950: communication device.

1. A test device which runs an application program that performs a series of function call processes utilizing a software platform, thereby testing the software platform, the test device comprising:
processing circuitry
to run the application program a plurality of times repeatedly so as to acquire a trace log including a plurality of trace results obtained by tracing the series of function call processes, the tracing results including an argument and a return value, of a function called by the series of function call processes,
to analyze the trace log statistically so as to estimate, as a variable attribute, each of an attribute of the argument and an attribute of the return value, of the function called by the series of function call processes, and
to generate a simulation program which simulates the series of function call processes using the variable attribute.

2. The test device according to claim 1,
wherein the processing circuitry runs the simulation program, acquires, as a simulation result, the argument and the return value, of the function called by the series of function call processes, and judges whether an attribute of the simulation result satisfies an expectation value.

3. The test device according to claim 1,
wherein the processing circuitry
generates a function call table in which the argument and the return value, of the function called by the series of function call processes are each attached with a variable attribute tag indicating the variable attribute, and
generates the simulation program using the function call table.

4. The test device according to claim 1,
wherein the processing circuitry analyzes the trace log statistically to estimate, as the variable attribute, a variable type which expresses a type of the argument and a type of the return value, of the function called by the series of function call processes.

5. The test device according to claim 1,
wherein the processing circuitry analyzes the trace log statistically to estimate, as the variable attribute, a borrowed portion where the argument and the return value, of the function called by the series of function call processes are borrowed.

6. The test device according to claim 1,
wherein the processing circuitry
classifies the plurality of trace results included in the trace log, as similar trace logs based on an order of function calls included in each of the plurality of trace results,
estimates the variable attribute in units of similar trace logs, and
generates the simulation program in units of similar trace logs.

7. The test device according to claim 1,
wherein the processing circuitry runs the application program a plurality of times repeatedly at a run-regulating interval which expresses an interval of run of the application program.

8. The test device according to claim 1,
wherein the processing circuitry initializes the software platform each time the application program is run.

9. A test method of a test device which runs an application program that performs a series of function call processes utilizing a software platform, thereby testing the software platform, the test method comprising:
running the application program a plurality of times repeatedly so as to acquire a trace log including a plurality of trace results obtained by tracing the series of function call processes, the tracing results including an argument and a return value, of a function called by the series of function call processes;
analyzing the trace log statistically so as to estimate, as a variable attribute, each of an attribute of the argument and an attribute of the return value, of the function called by the series of function call processes; and
generating a simulation program which simulates the series of function call processes, using the variable attribute of each of the argument and the return value, of the function called by the series of function call processes.

10. A non-transitory computer readable medium storing a test program of a test device which runs an application program that performs a series of function call processes utilizing a software platform, thereby testing the software platform, the test program causing the test device, being a computer, to execute:
a log acquisition process of running the application program a plurality of times repeatedly so as to acquire a trace log including a plurality of trace results obtained by tracing the series of function call processes, the tracing results including an argument and a return value, of a function called by the series of function call processes;
a log analysis process of analyzing the trace log statistically so as to estimate, as a variable attribute, each of an attribute of the argument and an attribute of the return value, of the function called by the series of function call processes; and
a program generation process of generating a simulation program which simulates the series of function call processes, using the variable attribute of each of the argument and the return value, of the function called by the series of function call processes.
